(19) United States
(12) Patent Application Publication
(10) Pub. No.: US 2026/0121672 A1
(43) Pub. Date: Apr. 30, 2026

(54) ELECTRONIC DEVICE FOR CONTROLLING RADIO WAVE FOCUSING DEVICE AND OPERATING METHOD THEREOF

(71) Applicant: ELECTRONICS AND TELECOMMUNICATIONS RESEARCH INSTITUTE, Daejeon (KR)

(72) Inventors: Wonyoung SONG, Sejong-si (KR); Kwang Jae LEE, Daejeon (KR); Jangyong AHN, Daejeon (KR); Soon Ik JEON, Daejeon (KR)

(73) Assignee: ELECTRONICS AND TELECOMMUNICATIONS RESEARCH INSTITUTE, Daejeon (KR)

(21) Appl. No.: 19/034,887

(22) Filed: Jan. 23, 2025

(30) Foreign Application Priority Data
May 10, 2024 (KR) 10-2024-0062106

(51) Int. Cl. H04B 1/04; H04B 7/06; H04B 17/12; H04B 17/16

(52) U.S. Cl. CPC H04B 1/0475; H04B 7/0617; H04B 17/12; H04B 17/16

(57) ABSTRACT

Disclosed are an electronic device for controlling a radio wave focusing device and an operating method thereof. The operating method of the electronic device includes obtaining a magnitude difference by channels and a phase difference by channels based on a plurality of input radio waves generated by a radio wave generating device and a plurality of output radio waves output by a radio wave focusing device, wherein the magnitude difference by channels and the phase difference by channels are a magnitude difference and a phase difference between an input radio wave and an output radio wave determined for each channel, determining a lookup table (LUT) to which a control input is mapped, obtaining a plurality of radio waves from the radio wave focusing device, determining the plurality of radio waves and an error for the plurality of radio waves, and updating the LUT based on the error.

### CROSS-REFERENCE TO RELATED APPLICATION(S)

This application claims the priority benefit of Korean Patent Application No. 10-2024-0062106 filed on May 10, 2024, in the Korean Intellectual Property Office, the disclosure of which is incorporated herein by reference for all purposes.

### BACKGROUND

### 1. Field

One or more example embodiments relate to an electronic device for controlling a radio wave focusing device and an operating method thereof.

### 2. Description of Related Art

Invasive treatments, such as incisional surgery, are generally used for intractable diseases, such as some types of cancer. However, these treatments cause side effects, such as physical burden or pain, or aftereffects to patients. In this regard, non-invasive treatment techniques may be used by radiating high-density energy from the outside to the inside of a target object for treatment. The non-invasive treatment techniques may include radiation therapy, ultrasound therapy, or radiofrequency energy therapy. Radiation therapy has the problem of radiation exposure, and internal structures, such as bones, may restrict ultrasound therapy. Therefore, research has been conducted using radio wave energy that does not cause these problems.

Treatments using radio wave energy may be a method of radiating a radio wave with controlled magnitude and phase from the outside of a target object, focusing radio wave energy on an internal lesion, and increasing the temperature of the lesion for treatment. These treatments may place an array antenna including a plurality of antennas outside the target object, and each antenna may radiate a radio wave with controlled magnitude and phase to focus radio wave energy on a desired position. In this case, the magnitude and phase of a radio wave radiated from each antenna are relative values by channels, and a focused position may be determined depending on magnitude and phase differences by channels.

### SUMMARY

The present disclosure provides an electronic device for focusing radio waves of a desired magnitude and phase on a desired position by controlling a radio wave control device included in a radio wave focusing device and an operating method thereof.

The present disclosure provides an electronic device for obtaining a lookup table (LUT) for controlling antennas by using a calibration device and an operating method thereof.

The present disclosure provides an electronic device for updating an LUT in real time by using a radio wave focusing device and an operating method thereof.

According to an aspect, there is provided an operating method of an electronic device including: obtaining a magnitude difference by channels and a phase difference by channels based on a plurality of input radio waves generated by a radio wave generating device and a plurality of output radio waves output by a radio wave focusing device, in which the magnitude difference by channels and the phase difference by channels are a magnitude difference and a phase difference between an input radio wave and an output radio wave determined for each channel; determining an LUT to which a control input is mapped, in which the control input controls the radio wave focusing device to output a plurality of target radio waves based on the magnitude difference by channels and the phase difference by channels; obtaining a plurality of radio waves from the radio wave focusing device by applying the control input of the LUT to the radio wave focusing device; determining the plurality of radio waves and an error for the plurality of radio waves based on the plurality of target radio waves; and updating the LUT based on the error.

According to an embodiment, the obtaining of the magnitude difference by channels and the phase difference by channels may include obtaining the magnitude difference by channels and the phase difference by channels from a signal comparator of a calibration device connected to a radio wave radiation device and the radio wave generating device of the radio wave focusing device.

According to an embodiment, the magnitude difference by channels and the phase difference by channels may be determined based on a difference between an input radio wave generated by the radio wave generating device and the plurality of output radio waves.

According to an embodiment, the calibration device may include the signal comparator and a phantom that is electrically connected to the signal comparator through a probe, in which the phantom is configured to collect the plurality of output radio waves from the radio wave focusing device through the probe.

According to an embodiment, the magnitude difference by channels may include a magnitude difference obtained by fixing an input for an attenuator of the radio wave focusing device and a magnitude difference obtained by fixing an input for a phase shifter of the radio wave focusing device.

According to an embodiment, the phase difference by channels may include a phase difference obtained by fixing an input for an attenuator of the radio wave focusing device and a phase difference obtained by fixing an input for a phase shifter of the radio wave focusing device.

According to an embodiment, the determining of the LUT may include determining a reference matrix, which is a reference for the determining of the LUT, based on the magnitude difference by channels and the phase difference by channels and determining the LUT based on the reference matrix.

According to an embodiment, the determining of the error for the plurality of radio waves may include determining the magnitude difference by channels and the phase difference by channels based on the plurality of radio waves and the plurality of target radio waves.

According to an embodiment, the updating of the LUT based on the error may include updating the LUT based on the magnitude difference by channels and the phase difference by channels.

According to an embodiment, the operating method may further include controlling the radio wave focusing device based on the updated LUT, monitoring an output of the radio wave focusing device that is controlled based on the updated LUT, and calibrating the updated LUT in real time based on monitoring results.

According to an aspect, there is provided an electronic device including a processor configured to obtain a magnitude difference by channels and a phase difference by channels based on a plurality of input radio waves generated by a radio wave generating device and a plurality of output radio waves output by a radio wave focusing device, in which the magnitude difference by channels and the phase difference by channels are a magnitude difference and a phase difference between an input radio wave and an output radio wave determined for each channel, determine an LUT to which a control input is mapped, in which the control input controls the radio wave focusing device to output a plurality of target radio waves based on the magnitude difference by channels and the phase difference by channels, obtain a plurality of radio waves from the radio wave focusing device by applying the control input of the LUT to the radio wave focusing device, determine the plurality of radio waves and an error for the plurality of radio waves based on the plurality of target radio waves, and update the LUT based on the error.

According to an embodiment, the processor may obtain the magnitude difference by channels and the phase difference by channels from a signal comparator of a calibration device connected to a radio wave radiation device and the radio wave generating device of the radio wave focusing device.

According to an embodiment, the magnitude difference by channels and the phase difference by channels may be determined based on a difference between an input radio wave generated by the radio wave generating device and the plurality of output radio waves.

According to an embodiment, the calibration device may include the signal comparator and a phantom that is electrically connected to the signal comparator through a probe.

According to an embodiment, the magnitude difference by channels may include a magnitude difference obtained by fixing an input for an attenuator of the radio wave focusing device and a magnitude difference obtained by fixing an input for a phase shifter of the radio wave focusing device.

According to an embodiment, the phase difference by channels may include a phase difference obtained by fixing an input for an attenuator of the radio wave focusing device and a phase difference obtained by fixing an input for a phase shifter of the radio wave focusing device.

According to an embodiment, the processor may determine a reference matrix, which is a reference for the determining of the LUT, based on the magnitude difference by channels and the phase difference by channels, and may determine the LUT based on the reference matrix.

According to an embodiment, the processor may determine the magnitude difference by channels and the phase difference by channels based on the plurality of radio waves and the plurality of target radio waves.

According to an embodiment, the processor may update the LUT based on the magnitude difference by channels and the phase difference by channels.

According to an aspect, there is provided a radio wave focusing device including a radio wave generating device configured to generate an input radio wave and apply a radio wave control device; a radio wave control device that includes a plurality of phase shifters and a plurality of attenuators and is configured to control the input radio wave received from the radio wave generating device to a plurality of target radio waves; and a radio wave radiation device that is connected to the radio wave control device and is configured to radiate the plurality of target radio waves through an array antenna, in which the radio wave control device is connected to an electronic device configured to control the radio wave focusing device and controlled by the electronic device based on an LUT to which a control input for the plurality of phase shifters and the plurality of attenuators is mapped.

According to an embodiment of the present disclosure, an electronic device may focus radio waves of a desired magnitude and phase on a desired position by controlling a radio wave control device included in a radio wave focusing device.

According to an embodiment of the present disclosure, an electronic device may obtain an LUT for controlling antennas of a radio wave focusing device in advance by using a calibration device.

According to an embodiment of the present disclosure, an electronic device may correct an error by updating an LUT in real time when using a radio wave focusing device.

Additional aspects of example embodiments will be set forth in part in the description which follows and, in part, will be apparent from the description or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a block diagram illustrating a radio wave focusing device according to an embodiment of the present disclosure.

FIG. 2 is a block diagram illustrating a radio wave focusing device to which a calibration device according to an embodiment of the present disclosure is connected.

FIGS. 3 and 4 are diagrams each illustrating a phantom of the calibration device according to an embodiment of the present disclosure.

FIG. 5 is a flowchart illustrating an electronic device according to an embodiment of the present disclosure.

FIG. 6 is a diagram illustrating a lookup table (LUT) according to an embodiment of the present disclosure.

FIG. 7 is a diagram illustrating the effect of calibration according to an embodiment of the present disclosure.

FIG. 8 is a block diagram illustrating a method of calibrating a radio wave focusing device according to an embodiment of the present disclosure in real time.

FIG. 9 is a flowchart illustrating a method of calibrating a radio wave focusing device according to an embodiment of the present disclosure in real time.

### DETAILED DESCRIPTION

Hereinafter, examples are described in detail with reference to the accompanying drawings. The scope of the right, however, should not be construed as limited to the embodiments set forth herein. In the drawings, like reference numerals are used for like elements.

Various modifications may be made to the examples. Here, the examples are not construed as limited to the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular examples only and is not to be limiting of the examples. As used herein, the singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Hereinafter, example embodiments will be described in detail with reference to the accompanying drawings.

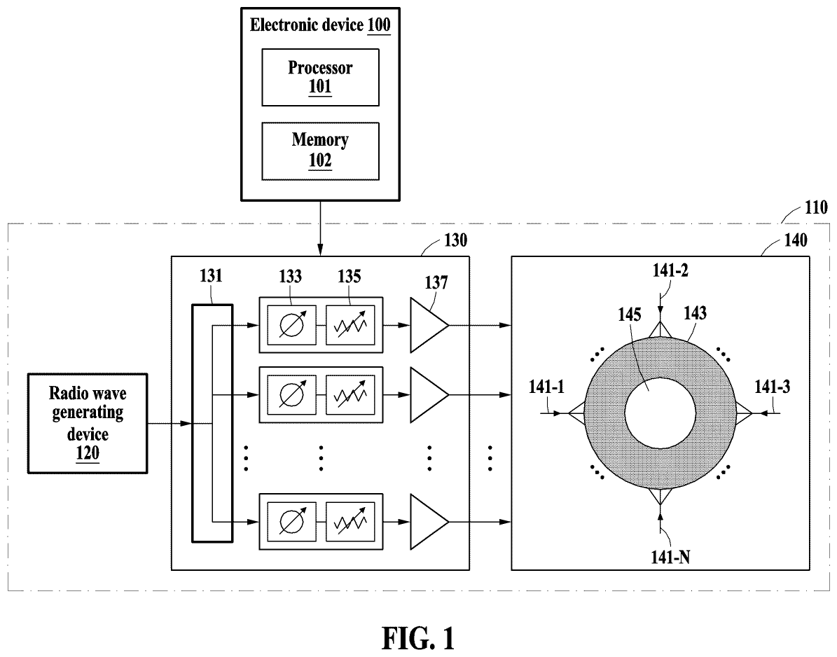

FIG. 1 is a block diagram illustrating a radio wave focusing device according to an embodiment of the present disclosure.

FIG. 1 illustrates an electronic device 100 and a radio wave focusing device 110 connected to the electronic device 100.

The electronic device 100 may be electrically connected to the radio wave focusing device 110 and may control the radio wave focusing device 110. Specifically, the electronic device 100 may transmit a control input for phase shifters and attenuators of the radio wave focusing device 110 to the radio wave focusing device 110.

The electronic device 100 may include a processor 101 and a memory 102. Only the components related to the present embodiments are illustrated in the electronic device 100 of FIG. 1. Thus, the electronic device 100 may also include other general-purpose components in addition to the components illustrated in FIG. 1.

The processor 101 may perform overall functions for controlling the electronic device 100. The processor 101 may generally control the electronic device 100 by executing programs and/or instructions stored in the memory 102. The processor 101 may be implemented as a central processing unit (CPU), a graphics processing unit (GPU), an application processor (AP), or the like, which is included in the electronic device 100, but examples are not limited thereto.

The memory 102 may be hardware for storing data having been processed or to be processed in the electronic device 100. In addition, the memory 102 may store an application or a driver to be driven by the electronic device 100. The memory 102 may include volatile memory, such as dynamic random-access memory (DRAM), and/or non-volatile memory.

The radio wave focusing device 110 may be a device that radiates a radio wave outside a target object 145 and focuses energy inside the target object 145. The target object 145 may be surrounded by a bolus 143. The target object 145 may vary depending on the use of the radio wave focusing device 110. For example, if the radio wave focusing device 110 is used for non-invasive treatment, the target object 145 may be a part where a lesion has occurred.

The radio wave focusing device 110 may include a radio wave generating device 120, a radio wave control device 130, and a radio wave radiation device 140. The radio wave generating device 120 may be a device that generates low-power radio waves. The radio control device 130 may branch the low-power radio waves generated from the radio wave generating device 120 into multiple channels and may amplify them into high-power radio waves. The radio wave radiation device 140 may radiate radio waves to the target object 145. The radio wave generating device 120, the radio wave control device 130, and the radio wave radiation device 140 may be electrically connected.

The radio wave generating device 120 may generate low-power radio waves. The radio waves generated from the radio wave generating device 120 may be transmitted to the radio wave control device 130.

The radio wave control device 130 may include a distributor 131, a plurality of phase shifters, a plurality of attenuators, and a plurality of amplifiers.

The distributor 131 may distribute the radio waves received from the radio wave generating device 120 equally to each channel. For example, if the radio wave focusing device 110 may radiate radio waves of eight channels, the distributor 131 may distribute the radio waves received from the radio wave generating device 120 to eight channels.

The distributor 131 may distribute the radio waves from the radio wave generating device 120 to phase shifters respectively corresponding to channels. For example, the distributor 131 may distribute the received radio waves to a phase shifter 133 corresponding to a first channel.

A phase shifter to which radio waves are distributed may control a phase of the distributed radio waves in response to a control input that is input from the electronic device 100. In this case, a phase shifter corresponding to each channel may differently control the distributed radio waves.

From a phase shifter, an attenuator may receive radio waves of which a phase is controlled. In response to a control input that is input from the electronic device 100, the attenuator may control the magnitude of the received radio waves of which the phase is controlled. For example, an attenuator 135 corresponding to the first channel may control the magnitude of the radio waves, received from the phase shifter 133, of which the phase is controlled. In this case, an attenuator corresponding to each channel may differently control the radio waves received, of which the phase is controlled.

The radio waves controlled through a phase shifter and an attenuator may be amplified by an amplifier. For example, the radio waves controlled through the phase shifter 133 and the attenuator 135 corresponding to the first channel may be amplified by an amplifier 137.

The radio waves amplified through an amplifier of each channel may be transmitted to the radio wave radiation device 140.

The radio wave radiation device 140 may include an array antenna and the bolus 143. The array antenna for radiating the radio waves received from the radio wave control device 130 may include a plurality of antenna elements (e.g., an antenna element 141-1, an antenna element 141-2, an antenna element 141-3 to an antenna element 141-N). In this case, N may correspond to the number of channels.

The bolus 143 may be between the array antenna and the target object 145. The bolus 143 may include a matching medium to match radio waves well and efficiently transmit them to the target object 145. Each of the antenna elements of the array antenna may surround the bolus 143 to focus radio waves on any position inside the target object 145.

A position on which radio waves are focused inside the target object 145 in the radio wave focusing device 110 may be determined based on the relative magnitude and phase (i.e., a weight by each channel) of radio waves radiated from each channel. Accordingly, to focus radio waves on a desired position, it may be important to control the magnitude and phase of radio waves by each channel. The relative magnitude and phase of radio waves to be output from each channel may be obtained through software to focus radio waves on a desired position.

However, components (e.g., phase shifters, attenuators, antenna elements, etc.) configuring the radio wave focusing device 110 may have an error even if the components are the same and/or have gone through the same production process. In addition, an assembly error may occur by each channel when producing the radio wave focusing device 110. Accordingly, even if the electronic device 100 provides the same control input, there may be a problem that each antenna element does not transmit radio waves of the same magnitude and phase. Thus, to solve this problem, a calibration method for radiating radio waves of magnitude and phase desired by each channel is described below.

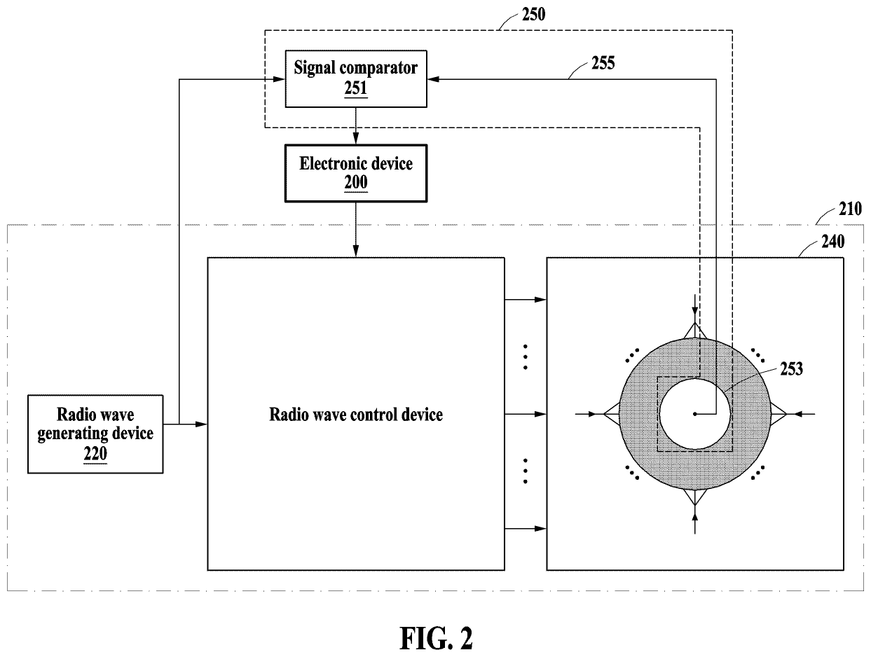

FIG. 2 is a block diagram illustrating a radio wave focusing device to which a calibration device according to an embodiment of the present disclosure is connected.

FIG. 2 illustrates an electronic device 200, a radio wave focusing device 210, and a calibration device 250. The radio wave focusing device 210 may include the calibration device 250 instead of a target object at a position where the target object is positioned. The descriptions of the electronic device 200 and the radio wave focusing device 210 are provided above with reference to FIG. 1 and thus are omitted.

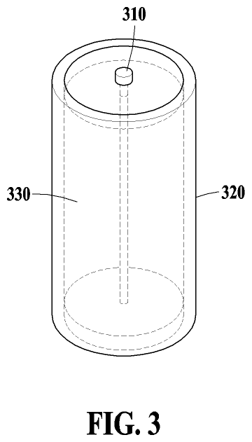

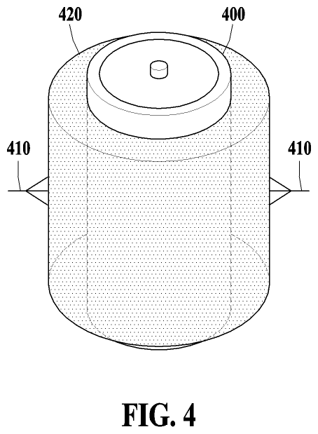

The calibration device 250 may include a signal comparator 251 and a phantom 253. The description of a phantom is provided below with reference to FIGS. 3 and 4. The phantom 253 may include a probe 255. The phantom 253 may be connected to the signal comparator 251 through the probe 255.

The signal comparator 241 may obtain a radio wave generated from a radio wave generating device 220 and a radio wave radiated from a radio wave radiation device 240 obtained through the phantom 253. The signal comparator 241 may compare the radio wave generated from the radio wave generating device 220 with the radio wave radiated from the radio wave radiation device 240 and may determine the difference.

In other words, the signal comparator 241 may compare a plurality of input radio waves obtained from the radio wave generating device 220 with a plurality of output radio waves obtained from the radio wave radiation device 240 and may determine a magnitude difference by channels and a phase difference by channels. The plurality of input radio waves obtained from the signal comparator 241 may include an input radio wave obtained from each channel. The plurality of output radio waves obtained from the radio wave radiation device 240 may include an output radio wave obtained from each channel.

The magnitude difference by channels may be a magnitude difference between an input radio wave and an output radio wave that is determined by each channel. The phase difference by channels may be a phase difference between an input radio wave that is determined by each channel and an output radio wave by each channel.

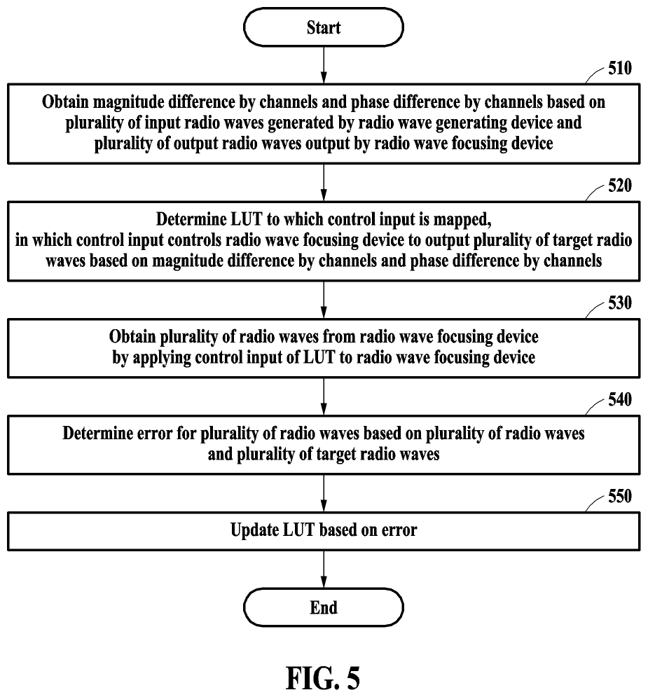

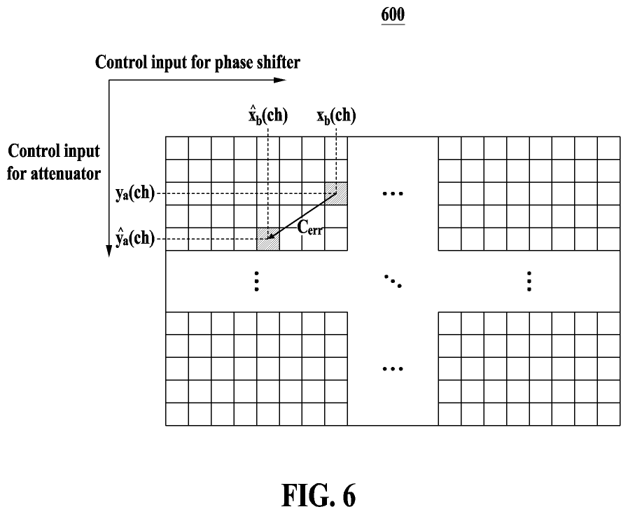

The magnitude difference by channels and the phase difference by channels, which are determined by the signal comparator 241, may be transmitted to the electronic device 200, and the electronic device 200 may determine control inputs of an attenuator and a phase shifter for outputting a radio wave having desired magnitude and phase to generate a lookup table (LUT). The method of generating an LUT and calibrating the LUT is described below with reference to FIGS. 5 and 6.

Hereinafter, the phantom 253 placed in place of the target object is described.

FIGS. 3 and 4 are diagrams each illustrating a phantom of the calibration device according to an embodiment of the present disclosure.

Referring to FIG. 3, a phantom 300 placed in place of a target object is described.

The phantom 300 may include a probe 310 and a housing 320. The housing 320 may include a material, such as plastic. The housing 320 may include a medium 330 which electrical properties are similar to those of the target object. The medium 330 may include a solid medium or a liquid medium. The housing 320 may include lids of the housing 320 at the top and at the bottom to easily put in or take out a medium.

The probe 310 may be placed at the center of the housing 320. The probe 310 may be positioned inside the phantom 300 (i.e., inside the housing 320) and may have omnidirectional sensing characteristics. Both ends of the probe 310 may be fixed to the lids.

FIG. 4 illustrates a phantom 400 placed in place of a target object, according to an embodiment.

The phantom 400 may be placed in place of the target object. Accordingly, the phantom 400 may be surrounded by a bolus of a radio wave radiation device. The phantom 400 may be placed in place of the target object and may receive a radio wave radiated by an antenna element 410.

FIG. 5 is a flowchart illustrating an electronic device according to an embodiment of the present disclosure.

Operations to be described hereinafter may be performed sequentially but not necessarily. For example, the order of the operations may change and at least two of the operations may be performed in parallel. Operations 510 to 550 may be performed by at least one component of the electronic device.

In operation 510, the electronic device may obtain a magnitude difference by channels and a phase difference by channels based on a plurality of input radio waves generated by a radio wave generating device and a plurality of output radio waves output by a radio wave focusing device.

The electronic device may obtain the magnitude difference by channels and the phase difference by channels from a signal comparator of a calibration device. The signal comparator may obtain the magnitude difference by channels and the phase difference by channels based on a radio wave obtained from the radio wave generating device of the radio wave focusing device and a radio wave by each channel obtained from a radio wave radiation device of the radio wave focusing device.

A radio wave obtained from a radio wave generating device to generate an LUT is a radio wave that is input to a radio wave control device, which may be referred to as an input radio wave. A radio wave obtained from a radio wave radiation device of the radio wave focusing device to generate an LUT may be referred to as an output radio wave.

The magnitude difference by channels and the phase difference by channels may be determined by the difference between an input radio wave and an output radio wave determined by each channel.

The signal comparator may determine magnitude difference and phase difference depending on a control input change for a phase shifter after fixing a control input for an attenuator. In this case, the magnitude difference depending on the control input change for the phase shifter after fixing the control input for the attenuator may be Pₘ(ch, x). The phase difference depending on the control input change for the phase shifter after fixing the control input for the attenuator may be Pₚ(ch, x).

The signal comparator may determine magnitude difference and phase difference depending on a control input change for an attenuator after fixing a control input for a phase shifter. In this case, the magnitude difference depending on the control input change for the attenuator after fixing the control input for the phase shifter may be Dₘ(ch, y). The phase difference depending on the control input change for the attenuator after fixing the control input for the phase shifter may be Dₚ(ch, y).

In this case, ch may be a value for a ch-th channel. x may be a control input variable for the phase shifter, and y may be a control input variable for the attenuator.

In this case, the phase difference by channels may include Pₚ(ch, x) and Dₚ(ch, y). The magnitude difference by channels may include Pₘ(ch, x) and Dₘ(ch, y).

In operation 520, the electronic device may determine an LUT to which a control input is mapped, in which the control input controls the radio wave focusing device to output a plurality of target radio waves based on the magnitude difference by channels and the phase difference by channels.

If controlling a plurality of radio waves to have the same magnitude, the magnitude difference between these radio waves should be 0 dB. In this case, the electronic device may determine a minimum magnitude value Magₘᵢₙ for a control input for all phase shifters of the radio wave focusing device. The electronic device may determine an attenuator control input index y_{ref}(ch) by channels based on Magₘᵢₙ. The electronic device may determine an LUT by using y_{ref}(ch).

Specifically, the electronic device may determine Magₘᵢₙ and y_{ref}(ch) based on Equation 1 below.

$${Mag}_{min} = {min}_{ch , x} ( {P}_{m} ( ch , x ) ) \qquad [ Equation 1 ]$$

$${y}_{ref} ( ch ) = {arg min}_{y} \vert {D}_{m} ( ch , y ) - {Mag}_{min} \vert$$

In addition, if controlling a plurality of radio waves to have the same phase, the phase difference between these radio waves should be 0 degrees. In this case, the electronic device may determine a maximum phase value Phsₘₐₓ for a control input for all attenuators of the radio wave focusing device based on y_{ref}(ch). The electronic device may determine a phase shifter control input index x_{ref}(ch) by channels based on Phsₘₐₓ. The electronic device may determine an LUT based on x_{ref}(ch).

Specifically, the electronic device may determine Phsₘₐₓ and x_{ref}(ch) based on Equation 2 below.

$${Phs}_{diff} ( ch ) = {D}_{p} ( ch , {y}_{ref} ( ch ) ) - {D}_{p} ( ch , 1 ) \qquad [ Equation 2 ]$$

$${Phs}_{max} = {max}_{ch} [ {P}_{p} ( ch , 1 ) + {Phs}_{diff} ( ch ) ]$$

$${x}_{ref} ( ch ) = {arg min}_{x} \vert {P}_{p} ( ch , x ) + {Phs}_{diff} ( ch ) - {Phs}_{max} \vert$$

The electronic device may determine an LUT based on a reference matrix, x_{ref}(ch), and y_{ref}(ch). The electronic device may determine the magnitude difference by channels and the phase difference by channels based on the reference matrix. Specifically, the electronic device may determine the reference matrix based on Equation 3 below.

$$\vert {C}_{dB} ( ch , x , y ) \vert = {P}_{m} ( ch , x ) + {D}_{m} ( ch , y ) - {D}_{m} ( ch , 1 ) [ in dB ] \qquad [ Equation 3 ]$$

$$∠ C ( ch , x , y ) = {P}_{p} ( ch , x ) + {D}_{p} ( ch , y ) - {D}_{p} ( ch , 1 ) [ in radian ]$$

Here, x=1 may be a first control input used when changing a control input for a phase shifter. y=1 may be a first control input used when changing a control input for an attenuator. In other words, x=1 and y=1 may be control inputs that are first input for the phase shifter and the attenuator to generate an LUT.

The electronic device may generate the LUT based on the reference matrix, x_{ref}(ch), and y_{ref}(ch). Specifically, the electronic device may generate the LUT based on Equation 4 below.

$$( {x}_{b} ( ch ) , {y}_{a} ( ch ) ) = {arg min}_{x , y} \vert [ C ( ch , x , y ) - {C}_{ref} ( ch ) ] - {10}^{- a / 10} \times exp ( jb ) \vert \qquad [ Equation 4 ]$$

$$C ( ch , x , y ) \} = {10}^{\frac{\vert {C}_{ds} ( ch , x , y ) \vert}{10}} \times exp [ j ∠ C ( ch , x , y ) ]$$

$${C}_{ref} ( ch ) = C ( ch , {x}_{ref} ( ch ) , {y}_{ref} ( ch ) )$$

Here, (x_{b}(ch), yₐ(ch)) may be a value, that is, a user input corresponding to a dB-magnitude attenuation and b rad-phase change. In other words, the LUT to which a control input corresponding to the a dB-magnitude attenuation and the b rad-phase change is mapped may be generated. The LUT to which a control input corresponding to the a dB-magnitude attenuation and the b rad-phase change for each of a plurality of channels is mapped may be generated. A control input is a control input for an attenuator and a phase shifter, which may be a weight for the attenuator and the phase shifter.

In operation 530, the electronic device may obtain a plurality of radio waves from the radio wave focusing device by applying the control input of the LUT to the radio wave focusing device.

The electronic device may apply the control input to the radio wave focusing device based on the LUT obtained from Equation 4. The radio wave focusing device that has obtained the control input based on the LUT may output the plurality of radio waves. The electronic device may determine whether the plurality of radio waves output from the radio wave focusing device is a plurality of target radio waves.

In operation 540, the electronic device may determine an error for the plurality of radio waves based on the plurality of radio waves and the plurality of target radio waves.

The electronic device may determine an error of the LUT based on the plurality of radio waves and the plurality of target radio waves.

In operation 550, the electronic device may update the LUT based on the error.

The method of determining the error of the LUT and correcting the error is described below with reference to FIG. 6.

FIG. 6 is a diagram illustrating an LUT according to an embodiment of the present disclosure.

FIG. 6 illustrates an LUT 600 of a ch channel.

An electronic device may input x_{b}(ch) and yₐ(ch) to a radio wave focusing device and may correct an error of a plurality of target radio waves and a plurality of radio waves output from the radio wave focusing device. The electronic device may calibrate x_{b}(ch) and yₐ(ch) to \hat{x}_{b}(ch) and ŷₐ(ch).

If inputting x_{b}(ch) and yₐ(ch) of the LUT 600 to the radio wave focusing device, Mₑᵣᵣ and Pₑᵣᵣ may be a magnitude error and a phase error of the target radio waves and the radio waves output from the radio wave focusing device. The electronic device may calculate Cₑᵣᵣ based on Mₑᵣᵣ and Pₑᵣᵣ. The electronic device may calibrate the LUT 600 based on Cₑᵣᵣ. In other words, the electronic device may calculate \hat{x}_{b}(ch) and ŷₐ(ch). Specifically, the electronic device may calibrate the LUT 600 based on Equation 5 below.

$${C}_{err} = {M}_{err} \times exp ( {jP}_{err} ) \qquad [ Equation 5 ]$$

$$( {\hat{x}}_{b} ( ch ) , {\hat{y}}_{a} ( ch ) ) = {arg min}_{x , y} [ \vert \{ C ( ch , x , y ) - C ( ch , {x}_{b} ( ch ) , {y}_{a} ( ch ) ) \} - {C}_{err} \vert ]$$

According to an embodiment, the electronic device may repeat the calibration method described above. The electronic device may repeatedly calibrate the LUT 600 by repeating the calibration method described above.

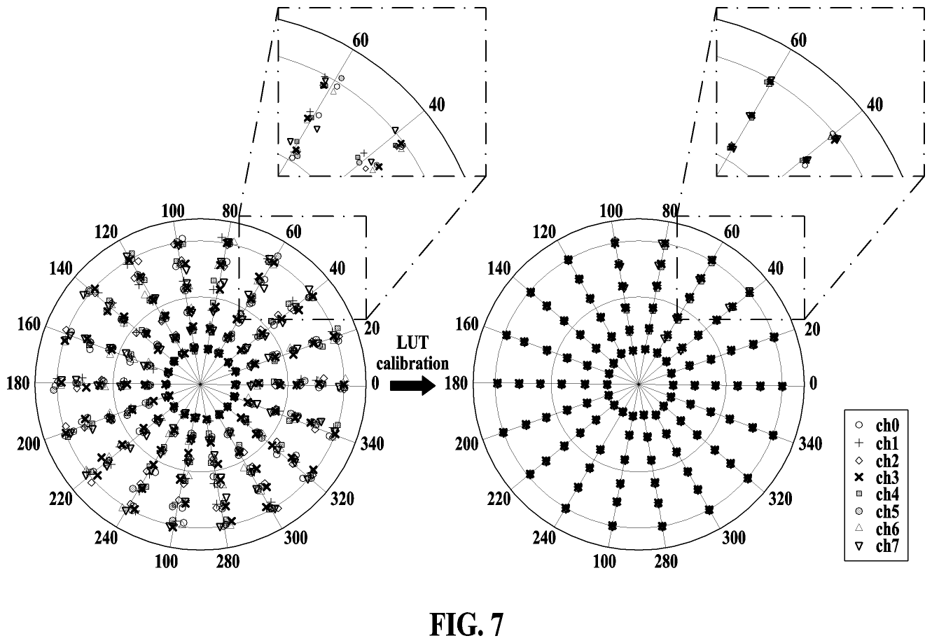

FIG. 7 is a diagram illustrating the effect of calibration according to an embodiment of the present disclosure.

FIG. 7 is a diagram illustrating a plurality of radio waves output from a radio wave focusing device based on an initial LUT and a plurality of radio waves output from the radio wave focusing device based on a corrected LUT. Referring to FIG. 7, the radio wave focusing device may output radio waves of 8 channels. FIG. 7 is a graph illustrating the plurality of radio waves output at intervals of 20-degree phase and 2 dB magnitude. Referring to FIG. 7, the radio waves of 8 channels output from the radio wave focusing device based on the corrected LUT may be more focused than the radio waves of 8 channels output from the radio wave focusing device based on the initial LUT.

The above-described methods may be calibration methods before irradiating a radio wave to a target object. Thus, if irradiating a radio wave to the target object, an error may occur. Hereinafter, the method of correcting an error in real time when irradiating a radio wave to the target object is described.

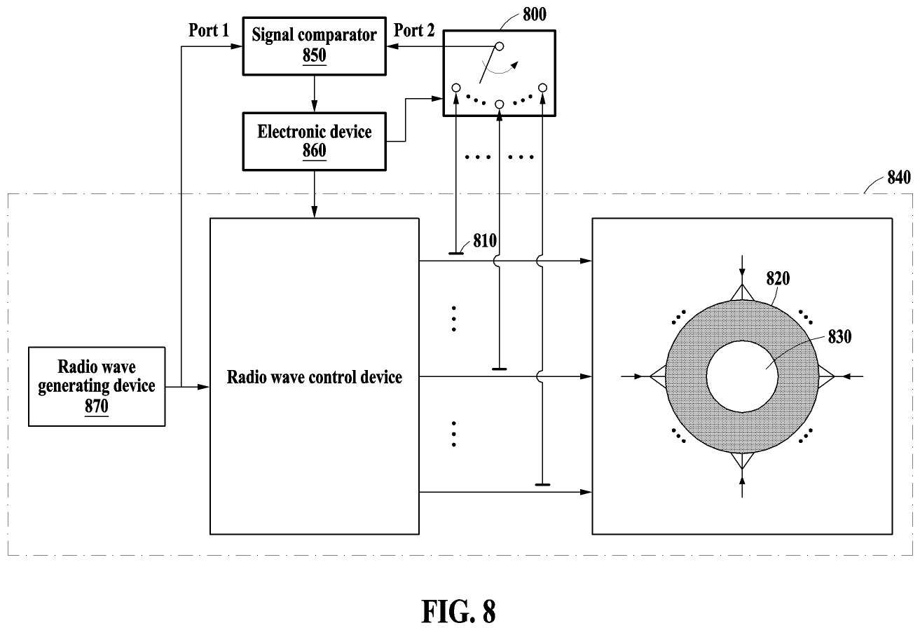

FIG. 8 is a block diagram illustrating a method of calibrating a radio wave focusing device according to an embodiment of the present disclosure in real time.

Unlike the pre-LUT calibration described above, a target object 830 that is not a calibration device may be placed. For real-time calibration, an N:1 switch 800 may be connected to a radio wave focusing device 840 through a coupler 810. The coupler 810 may obtain an output signal by each channel. The coupler 810 may transmit the obtained output signal by each channel to the N:1 switch 800.

A signal comparator 850 may obtain an output signal of a specific channel through the N:1 switch 800. The signal comparator 850 may compare the obtained output signal of the specific channel with an input signal obtained from a radio wave generating device 870. The signal comparator 850 may determine magnitude difference and phase difference of the specific channel.

An electronic device 860 may obtain the magnitude difference and the phase difference from the signal comparator 850. The electronic device 860 may update an LUT based on the magnitude difference and the phase difference obtained from the signal comparator 850.

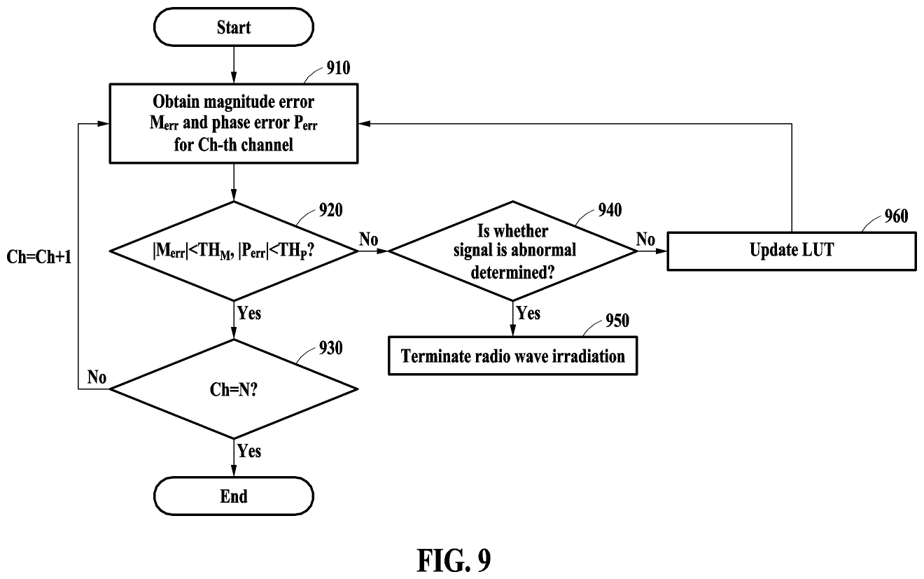

The method of updating the LUT is described below with reference to FIG. 9.

FIG. 9 is a flowchart illustrating a method of calibrating a radio wave focusing device according to an embodiment of the present disclosure in real time.

Operations to be described hereinafter may be performed sequentially but not necessarily. For example, the order of the operations may change and at least two of the operations may be performed in parallel. Operations 910 to 960 may be performed by at least one component of an electronic device.

In operation 910, the electronic device may obtain a magnitude error Mₑᵣᵣ and a phase error Pₑᵣᵣ for a Ch-th channel.

For example, Ch may be 1. The electronic device may obtain the magnitude error Mₑᵣᵣ and the phase error Pₑᵣᵣ of a specific channel from a signal comparator. Alternatively, the electronic device may determine the magnitude error Mₑᵣᵣ and the phase error Pₑᵣᵣ of the specific channel.

The electronic device may obtain an output Cₒᵤₜ(ch) for the ch-th channel from the signal comparator. If the input/output differences of an antenna, a coupler, and an N:1 switch of the ch-th channel are Δₐ(ch), Δ_{c}(ch), and Δₛ(ch), respectively, a difference Cₒᵤₜ′(ch) between an input signal obtained from a radio wave generating device and an actually transmitted output signal is determined as shown in Equation 6.

$${C}_{out}^{′} ( ch ) = {C}_{out} ( ch ) + {Δ}_{a} ( ch ) - {Δ}_{c} ( ch ) - {Δ}_{s} ( ch ) \qquad [ Equation 6 ]$$

The magnitude of Cₒᵤₜ′(ch) may be a magnitude error Mₑᵣᵣ. The phase of Cₒᵤₜ′(ch) may be a phase error Mₑᵣᵣ.

In operation 920, the electronic device may determine whether a magnitude error is less than a threshold value TH_{M} and a phase error is less than a threshold value TH_{P}.

In other words, the electronic device may determine whether the magnitude error and the phase error are within an acceptable range.

If the magnitude error is less than the threshold value TH_{M}, and the phase error is less than the threshold value TH_{P}, the electronic device may perform operation 930. If the magnitude error is not less than the threshold value TH_{M}, and the phase error is not less than the threshold value TH_{P}, the electronic device may perform operation 940.

In operation 930, the electronic device may determine whether the Ch-th channel is the last channel (i.e., an Nth channel).

In operation 940, the electronic device may determine whether a signal is abnormal.

In other words, if the magnitude error is not less than the threshold value TH_{M}, and the phase error is not less than the threshold value TH_{P}, the electronic device may determine whether a signal output by the radio wave focusing device is abnormal.

Various examples of signal abnormality may be included. For example, the electronic device may determine whether a plurality of radio waves is misfocused on a wrong position. For example, the electronic device may determine whether a control input (i.e., a weight) for a phase shifter and/or an attenuator is misapplied. In other words, the electronic device may determine whether the magnitude of a radio wave output by the radio wave focusing device is abnormal. However, this is just an example, and the present disclosure is not limited thereto.

If signal abnormality occurs, various problems may occur. Specifically, if a control input for a phase shifter and/or an attenuator is misapplied, major damage may occur to a target object.

Accordingly, the electronic device may determine whether signal abnormality has occurred, and, if signal abnormality has occurred, may perform operation 950. If signal abnormality has not occurred, the electronic device may perform operation 960.

In operation 950, the electronic device may control the radio wave focusing device to terminate radio wave irradiation.

As described above in operation 940, if signal abnormality has occurred, major damage may occur to the target object. Thus, the electronic device may terminate the radio wave irradiation of the radio wave focusing device.

In operation 960, if it is determined that there is no signal abnormality, the electronic device may update an LUT.

The method of updating the LUT described above with reference to FIGS. 1 to 7 may also apply, and thus the detailed description thereof is omitted.

Operations 910 to 960 described above may be periodically performed based on a set cycle.

Using the method described in the present disclosure may enable radio waves with a desired magnitude and phase to be transmitted by calibrating output errors by channels caused due to manufacturing error problems with devices. In addition, using the method described in the present disclosure may enable a radio wave to be accurately focused on a desired position inside a target object by calibrating an LUT in real time.

The method according to the present disclosure may be written in a computer-executable program and may be implemented as various recording media, such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), RAM, flash memory, erasable programmable ROM (EPROM), or electrically erasable programmable ROM (EEPROM). The processor and the memory may be supplemented by or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the present disclosure but are not intended to limit the scope of the present disclosure. It will be apparent to one of ordinary skill in the art that various modifications based on the technical spirit of the present disclosure, as well as the disclosed embodiments, can be made.

What is claimed is:

1. An operating method of an electronic device, the operating method comprising:
obtaining a magnitude difference by channels and a phase difference by channels based on a plurality of input radio waves generated by a radio wave generating device and a plurality of output radio waves output by a radio wave focusing device, wherein the magnitude difference by channels and the phase difference by channels are a magnitude difference and a phase difference between an input radio wave and an output radio wave determined for each channel;
determining a lookup table (LUT) to which a control input is mapped, wherein the control input controls the radio wave focusing device to output a plurality of target radio waves based on the magnitude difference by channels and the phase difference by channels;
obtaining a plurality of radio waves from the radio wave focusing device by applying the control input of the LUT to the radio wave focusing device;
determining the plurality of radio waves and an error for the plurality of radio waves based on the plurality of target radio waves; and
updating the LUT based on the error.

2. The operating method of claim 1, wherein the obtaining the magnitude difference by channels and the phase difference by channels comprises obtaining the magnitude difference by channels and the phase difference by channels from a signal comparator of a calibration device connected to a radio wave radiation device and the radio wave generating device of the radio wave focusing device.

3. The operating method of claim 2, wherein the magnitude difference by channels and the phase difference by channels are determined based on a difference between an input radio wave generated by the radio wave generating device and the plurality of output radio waves.

4. The operating method of claim 2, wherein the calibration device comprises:
the signal comparator; and
a phantom that is electrically connected to the signal comparator through a probe,
wherein the phantom is configured to collect the plurality of output radio waves from the radio wave focusing device through the probe.

5. The operating method of claim 2, wherein the magnitude difference by channels comprises a magnitude difference obtained by fixing an input for an attenuator of the radio wave focusing device and a magnitude difference obtained by fixing an input for a phase shifter of the radio wave focusing device.

6. The operating method of claim 2, wherein the phase difference by channels comprises a phase difference obtained by fixing an input for an attenuator of the radio wave focusing device and a phase difference obtained by fixing an input for a phase shifter of the radio wave focusing device.

7. The operating method of claim 1, wherein the determining the LUT comprises:
determining a reference matrix, which is a reference for the determining of the LUT, based on the magnitude difference by channels and the phase difference by channels; and
determining the LUT based on the reference matrix.

8. The operating method of claim 1, wherein the determining the error for the plurality of radio waves comprises determining the magnitude difference by channels and the phase difference by channels based on the plurality of radio waves and the plurality of target radio waves.

9. The operating method of claim 8, wherein the updating the LUT based on the error comprises updating the LUT based on the magnitude difference by channels and the phase difference by channels.

10. The operating method of claim 1, further comprising:
controlling the radio wave focusing device based on the updated LUT;
monitoring an output of the radio wave focusing device that is controlled based on the updated LUT; and
calibrating the updated LUT in real time based on monitoring results.

11. An electronic device comprising:
a processor configured to obtain a magnitude difference by channels and a phase difference by channels based on a plurality of input radio waves generated by a radio wave generating device and a plurality of output radio waves output by a radio wave focusing device, wherein the magnitude difference by channels and the phase difference by channels are a magnitude difference and a phase difference between an input radio wave and an output radio wave determined for each channel, determine a lookup table (LUT) to which a control input is mapped, wherein the control input controls the radio wave focusing device to output a plurality of target radio waves based on the magnitude difference by channels and the phase difference by channels, obtain a plurality of radio waves from the radio wave focusing device by applying the control input of the LUT to the radio wave focusing device, determine the plurality of radio waves and an error for the plurality of radio waves based on the plurality of target radio waves, and update the LUT based on the error.

12. The electronic device of claim 11, wherein the processor is further configured to obtain the magnitude difference by channels and the phase difference by channels from a signal comparator of a calibration device connected to a radio wave radiation device and the radio wave generating device of the radio wave focusing device.

13. The electronic device of claim 12, wherein the magnitude difference by channels and the phase difference by channels are determined based on a difference between an input radio wave generated by the radio wave generating device and the plurality of output radio waves.

14. The electronic device of claim 12, wherein the calibration device comprises:
the signal comparator; and
a phantom that is electrically connected to the signal comparator through a probe.

15. The electronic device of claim 12, wherein the magnitude difference by channels comprises a magnitude difference obtained by fixing an input for an attenuator of the radio wave focusing device and a magnitude difference obtained by fixing an input for a phase shifter of the radio wave focusing device.

16. The electronic device of claim 12, wherein the phase difference by channels comprises a phase difference obtained by fixing an input for an attenuator of the radio wave focusing device and a phase difference obtained by fixing an input for a phase shifter of the radio wave focusing device.

17. The electronic device of claim 11, wherein the processor is further configured to determine a reference matrix, which is a reference for the determining of the LUT, based on the magnitude difference by channels and the phase difference by channels, and determine the LUT based on the reference matrix.

18. The electronic device of claim 11, wherein the processor is further configured to determine the magnitude difference by channels and the phase difference by channels based on the plurality of radio waves and the plurality of target radio waves.

19. The electronic device of claim 18, wherein the processor is further configured to update the LUT based on the magnitude difference by channels and the phase difference by channels.

20. A radio wave focusing device comprising:
a radio wave generating device configured to generate an input radio wave and apply a radio wave control device;
a radio wave control device that comprises a plurality of phase shifters and a plurality of attenuators and is configured to control the input radio wave received from the radio wave generating device to a plurality of target radio waves; and
a radio wave radiation device that is connected to the radio wave control device and is configured to radiate the plurality of target radio waves through an array antenna,
wherein the radio wave control device is connected to an electronic device configured to control the radio wave focusing device and controlled by the electronic device based on a lookup table (LUT) to which a control input for the plurality of phase shifters and the plurality of attenuators is mapped.
